(19) United States
(12) Patent Application Publication
(10) Pub. No.: US 2010/0031319 A1
(43) Pub. Date: Feb. 4, 2010

(54) Secure messaging using caller identification

(75) Inventors: Ram Cohen, Tel Aviv (IL); Ariel Walersztajn, Ashdod (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/462,430

(22) Filed: Aug. 3, 2009

Related U.S. Application Data
(60) Provisional application No. 61/085,887, filed on Aug. 4, 2008.

(51) Int. Cl. G06F 21/00; H04W 4/12; G06F 15/16

(52) U.S. Cl. 726/3; 455/466; 709/206; 709/227

(57) ABSTRACT

A method of securing an electronic message from a sender to a recipient comprising the step of restricting access to content of message at a recipient terminal unless an session is opened by transmission of a signal from equipment of the recipient via a second communication channel.

### PRIORITY INFORMATION

The present invention claims priority to U.S. Provisional Application No. 61/085,887 filed on Aug. 4, 2008, and makes reference herein to same in its entirety.

### FIELD OF THE INVENTION

The present invention relates to secure messaging, and particularly to methods for securing emails.

### BACKGROUND

Emailing has a number of advantages as a means of communication. Email messages are generally quickly delivered, retrievable via a large variety of end user terminals from almost anywhere where people may be found.

Generally comprising digital text, they are easily stored, may be automatically sorted, forwarded without degradation. Other types of content, including text files, sound files and animations may be attached to emails.

Although accessible anywhere, email messages are generally sent from a discrete sender to one or a small, discrete number of recipients, so the medium is often used for transmitting confidential information.

However, emails may be misaddressed. A third party may be able to access someone's email program and even if protected, say by a password or the like, third parties may be able to hack into an email terminal and access email messages.

In consequence of the above, despite its convenience, email is not a recommended medium for transmitting sensitive data of a confidential nature, such as medical records, personal financial data and the like.

One approach for protecting email and other similar messaging methods is encryption. Classically, encryption relies on an encryption key and a corresponding decryption key. In the case of symmetric password, the encryption and decryption keys are the same and are often relatively short which makes them susceptible to brute force attacks. Since the user typically selects password which are easily memorized, a clever hacker may guess the password using common combinations. Asymmetrical encryption uses very long keys, which makes it impractical to break using brute force. The problem with such encryption keys is that unlike short passwords, they cannot be memorized by the user, and thus must be stored on the terminal or on a media device, and are susceptible to hackers acting at that terminal or accessing it remotely. Additionally, it will be appreciated that such solutions are not readily usable by parties accessing from a public terminal, such as in an internet cafe, or logging on to a remote exchange terminal or web mail account as a guest on someone else's computer.

There is a need for methods of safely transmitting contents via encrypted emails that are readily accessible from any terminal, are well protected from hackers and do not require the user to remember complicated passwords, and the present invention addresses this need.

### SUMMARY OF THE INVENTION

The present invention is directed to a method of securing an electronic message from a sender to a recipient comprising the step of restricting access to content of the message transmitted via a first communication channel from a sender terminal to a recipient terminal for interfacing with the recipient, until transmission of a signal via a second communication channel emanating from equipment of the recipient is received.

In typical embodiments, the electronic message is an email.

Typically restricting access comprises encrypting or denying access.

In some configurations, once the signal is received, access is permitted for a maximum predetermined time interval.

In other configurations, once the signal is received, access is granted to a plurality of messages sent from the sender to the recipient.

In still other configurations, once the signal is received, access is permitted until a session is terminated by the recipient actively logging off the recipient terminal or until a period of time passes without recipient interaction with the recipient terminal.

Optionally, the recipient terminal comprises a physical interface associated with the recipient.

Additionally or alternatively, the recipient terminal comprises a virtual interface associated with the recipient and accessible to the recipient by logging on remotely.

Typically the signal comprises a telephony signal.

Optionally the signal comprises the identification number or caller ID of equipment of the recipient.

Additionally or alternatively, he signal comprises the identification number of the interface.

Optionally, the signal comprises an SMS.

Optionally, the signal comprises service data such as Unstructured Supplementary Service Data (USSD).

Optionally, the second communication channel comprises a telephony link of a telecommunication network.

Optionally, the telephony link is required to originate from a telecommunication terminal with a specific number/identification.

Alternatively, the signal comprises service data sent to a telephone network provider that forwards said signal to sender of the secure message.

Optionally, the second communication channel comprises an Internet connection and the signal is data inserted to a website other than email server site.

In some embodiments the signal comprises a biometric identification of the recipient.

Optionally, the signal comprises information regarding which of a plurality of messages previously sent to the recipient may be accessed.

### DESCRIPTION OF THE FIGURE

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

FIG. 1 is a schematic illustration of a system for enabling access to restricted messages by desired recipient only in accordance with one embodiment of the invention, and

FIG. 2 is a flow chart of the method of an embodiment of the invention.

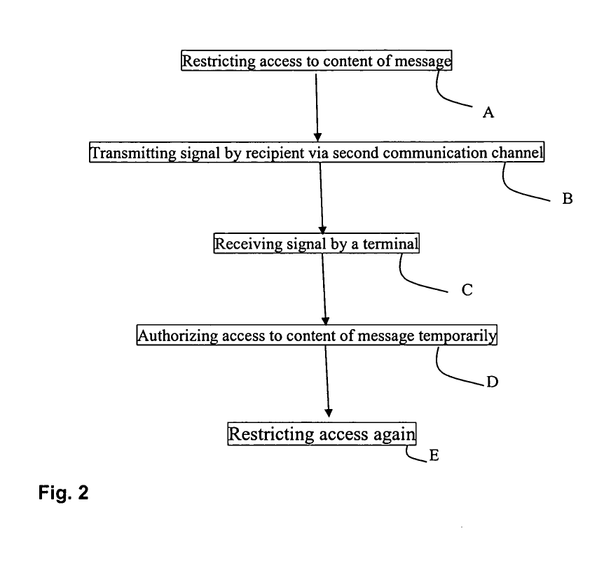

### DESCRIPTION OF EMBODIMENTS

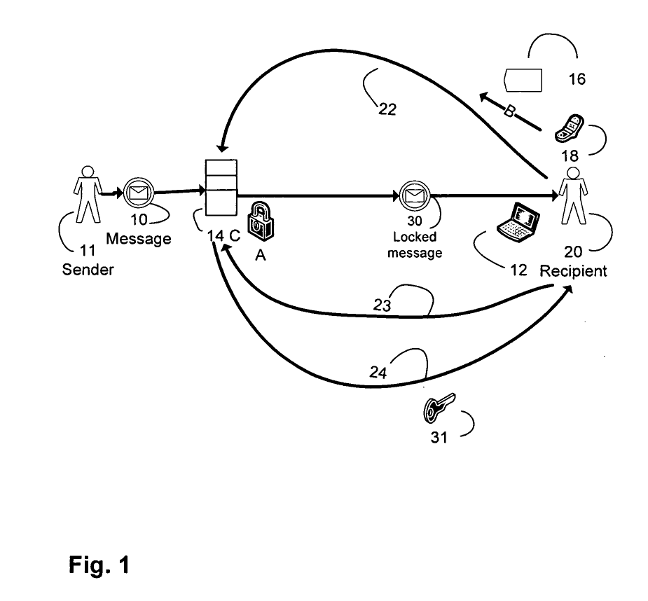

With reference to FIG. 1, the present invention is directed to a method of securing an electronic message 10 from a sender 11, typically an email, comprising the step of restricting access to content of message 10 by encryption or locking ‘A’ of the message 10 at sender terminal 14 ‘C’ and sending the locked message 30 to the desired recipient 20. In order to gain access to the content of message 10, the recipient 20 needs to open a session by transmission ‘B’ of a signal 16 from his equipment 18 via a second communication channel 22. The second communication channel 22 is typically a telephone link via a telephone network, which may be a pretty ordinary, wired telephone system, but may be a cellular link over a cellular network. Indeed, it will be appreciated that cellular and non-cellular networks tend to interlink so the second communication channel 22 may be partly wired and partly wireless and/or cellular, and may include Bluetooth connections, satellite links, relay terminals, Wi-Fi, WiMax and the like.

Once the transmitted signal is received by sender terminal 14 an access interval or window is opened ‘D’. This may be a pre-fixed time period such as three minutes from transmission/reception of the signal 16, or may be limited by a predetermined number of messages, or to one or more specific messages, identified by a code number. The window D may be a single interaction period that is terminated by the recipient 20 actively logging off from the recipient terminal 12, or the window may be terminated by a period of time without interaction, such as two minutes without a keystroke for example. As long as the window ‘D’ is open, the recipient 20 can perform a request 23 to the sender terminal 14 in order to receive a response 24 that contains information 31 that is required to gain access to the content of message 10, such as a decryption key, for example. Once the windows ‘D’ is closed, access to the emails becomes restricted once again ‘E’. The recipient terminal 12 may be a specific terminal, i.e. a physical interface associated with the recipient 20 and perhaps identified by a particular chip serial number or motherboard serial number, or a physical location, such as a modem connected to a specific telephone line and/or perhaps preconfigured by running specific software and/or perhaps using GPS data, or identified by a specific IP address, for example. Alternatively, the recipient terminal 12 may be a virtual terminal at a specific address on the internet, logged onto remotely by the user, herein the desired recipient 20, typically via user names, passwords and the like.

The signal 16 used to initiate a session typically comprises a telephony signal, such as a dial-up to a specific number. Optionally, the signal is merely a dial-up, it being appreciated that a caller using a dedicated telephony handset, such as a personal mobile phone or PDA, identified with a dedicated number, may be identified by recognition of the number by dialed up hardware during the handshake, prior to the call being answered, i.e. a connection being established. In this manner, costs may be minimized by not requiring a message to be answered, thereby not requiring a telephone call unit. Additionally or alternatively, the recipient 20 of the email may be required to identify himself/herself by typing in a password or making other selections. Unlike, prior art passwords, it will be appreciated that by requiring the password to be sent over a separate line, it is inherently more secure. The identification may require the recipient 20 to speak so that voice recognition software can be used for identification purposes. The recipient 20 could audibly sound a preset signal, i.e. an audible password, which may be a long string of digitized data, coded like a facsimile sound for data transmission. Many mobile phones include a digital camera, and in some embodiments, requiring high security, the recipient transmits a digital photographic image of himself, which may be required to be a still image or a video image, and may include a time transmission for verification that the signal is transmitted in real time and not stored. The recipient 20 may be identified by automated biometric image analysis techniques, or by a person.

Once the system is assured that recipient 20 is who it is supposed to be, the contents of message 10 may be made accessible by transmitting the necessary information 31 via data link 24 upon request 23 Typically the system and method are configured such that the signal 16 and message 30 are sent over different networks. Preferably the system and method are configured such that the signal 16 is sent from a totally separate hardware terminal to that used for accessing the message. In various embodiments, the signal 16 may be carried via a second communication channel 22 comprises a telephony link of a telecommunication network. It may be an SMS or service code data (such as USSD), used by telephony service providers to enable various supplementary services, sent from a recipient's mobile phone 18 to telephony service provider for relaying to the message sender or to a trusted mediator thereof. The signal may include information regarding which message or messages needs to be accessed. In some embodiments, the telephony link is required to originate from a telecommunication terminal with a specific number, e.g. having a specific SIM card. In one embodiment, the second communication channel comprises service data sent to a telephone network provider that forwards the signal to the terminal 14 of the secure message 10. Optionally the second communication channel comprises an Internet connection and the signal 16 is data inserted to a website other than email server site.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

We claim:

1. A method of securing an electronic message from a sender to a recipient comprising the step of restricting access to content of the message transmitted via a first communication channel from a sender terminal to a recipient terminal for interfacing with the recipient, until transmission of a signal via a second communication channel emanating from equipment of the recipient is received.

2. The method of claim 1 wherein the electronic message is an email.

3. The method of claim 1 wherein the restricting access comprises either encrypting or denying access.

4. The method of claim 1 wherein once the signal is received, access is permitted for a maximum predetermined time interval.

5. The method of claim 1 wherein once the signal is received, access is granted to a plurality of messages sent from the sender to the recipient.

6. The method of claim 1 wherein once the signal is received, access is permitted until a session is terminated by the recipient actively logging off the recipient terminal or by period of time passing without a recipient interaction with the recipient terminal.

7. The method of claim 1 wherein the recipient terminal comprises a physical interface associated with the recipient.

8. The method of claim 1 wherein the recipient terminal comprises a virtual interface associated with the recipient and accessible to the recipient by logging on remotely.

9. The method of claim 1 wherein the signal comprises a telephony signal.

10. The method of claim 1 wherein the signal comprises the identification number or caller ID of equipment of the recipient.

11. The method of claim 1 wherein the signal comprises the identification number of the interface.

12. The method of claim 1 wherein the signal comprises an SMS.

13. The method of claim 1 wherein the signal comprises service data.

14. The method of claim 13 wherein the service data comprises Unstructured Supplementary Service Data (USSD).

15. The method of claim 1 wherein the second communication channel comprises a telephony link of a telecommunication network.

16. The method of claim 1 wherein the telephony link is required to originate from a telecommunication terminal with a specific number/identification.

17. The method of claim 1 wherein the signal comprises service data sent to a telephone network provider that forwards said signal to sender of the secure message.

18. The method of claim 1 wherein the second communication channel comprises an Internet connection and the signal is data inserted to a website other than email server site.

19. The method of claim 1 wherein the signal comprises a biometric identification of the recipient.

20. The method of claim 1 wherein the signal comprises information regarding which of a plurality of messages previously sent to the recipient may be accessed.
